(19) United States
(12) Patent Application Publication
(10) Pub. No.: US 2026/0326158 A1
(43) Pub. Date: Oct. 22, 2026

(54) Pressure washer and method for operating a pressure washer

(71) Applicant: Andreas Stihl AG & Co. KG, Waiblingen (DE)

(72) Inventors: Simon Nadler, Stuttgart (DE); Stefan Baßmann, Backnang (DE); Rainer Grohmann, Ludwigsburg (DE)

(73) Assignee: Andreas Stihl AG & Co. KG, Waiblingen (DE)

(21) Appl. No.: 19/632,103

(22) Filed: Mar. 27, 2026

(30) Foreign Application Priority Data
Mar. 28, 2025 (DE) 102025112257.1
Mar. 28, 2025 (DE) 102025112271.7

(51) Int. Cl. B08B 3/02

(52) U.S. Cl. CPC B08B 3/026; B08B 2203/0205

(57) ABSTRACT

A pressure washer has a high-pressure pump, a main line through which liquid can be conveyed by the high-pressure pump, a motor for driving the high-pressure pump, and a control element. The main line has a suction chamber upstream of the high-pressure pump and a pressure chamber downstream of the high-pressure pump. A bypass device between the pressure chamber and the suction chamber fluidically connects the pressure chamber and the suction chamber and has a bypass valve. To regulate pressure in the pressure chamber by the bypass valve, the size of an open cross-sectional area of the bypass device is adjustable depending on a degree of actuation of the control element. During a start-up phase of the motor, the bypass valve adjusts the size of the open cross-sectional area independently of the degree of actuation so that the bypass device fluidically connects the pressure chamber and the suction chamber.

### CROSS-REFERENCE TO RELATED APPLICATION

This application claims the benefit of German Patent Applications DE 102025112271.7, filed on Mar. 28, 2025, and DE 102025112257.1, filed on Mar. 28, 2025, the contents of which are incorporated in their entireties.

### TECHNICAL FIELD

The disclosure relates to a pressure washer and a method for operating a pressure washer.

### BACKGROUND

A pressure washer is known from EP 4 282 546 A1, in which a bypass device is provided between the pressure chamber and the suction chamber to establish a liquid connection between them. To regulate the pressure in the pressure chamber, the open cross-sectional area of the bypass device can be adjusted by means of a bypass valve depending on the degree of actuation of a control element. When starting the motor to drive the high-pressure pump, the high-pressure pump or the motor driving the high-pressure pump must operate against high pressure in the pressure chamber, particularly when the main line valve is closed. During the start-up phase, the torque or rotational frequency of the motor or the high-pressure pump is low, even though it has to work against a high back pressure. This can cause the motor to overheat and cut out during a start-up attempt.

### SUMMARY

An object of the disclosure is to improve a generic pressure washer in such a way that a reliable start-up of the motor of the high-pressure pump is ensured in a simple manner. This object is solved by a pressure washer as disclosed herein.

A further object of the disclosure is to specify a method for operating a pressure washer, by which a reliable start-up of the motor of the high-pressure pump is ensured in a simple manner. This object is solved by a method for operating a pressure washer as disclosed herein.

The pressure washer is configured such that the bypass valve adjusts the size of the open cross-sectional area of the bypass device, which provides a liquid connection between the pressure chamber and the suction chamber for a start-up phase of the motor, independently of the degree of actuation of the control element, such that the bypass device establishes a liquid connection between the pressure chamber and the suction chamber. This enables the motor driving the high-pressure pump, or the high-pressure pump itself, to circulate liquid through the bypass device from the pressure chamber to the suction chamber during the start-up phase, without the motor having to work against high back pressure with initially low torque or low rotational frequency. In this way, the motor can reach a rotational frequency during the start-up phase of the motor with which the motor can then provide a sufficient torque in the case of corresponding back pressure. In particular, the motor must only begin to work against a higher pressure in the pressure chamber once it has reached this rotational frequency. In this way, it is avoided that the motor overheats and cuts out in the start-up phase during a start-up attempt. Due to the fact that the already present bypass device is used in order to be able to circulate the liquid between the pressure chamber and the suction chamber during the start-up phase, a reliable start-up of the motor of the high-pressure pump can be ensured in a simple manner. For this purpose, there is no need to provide any further components. The already present bypass device can be used for this purpose. This saves installation space and costs.

In particular, the liquid flows in a flow direction starting from the pressure chamber through the bypass device, in particular the bypass line and the bypass valve, towards the suction chamber. In particular, the open cross-sectional area is oriented perpendicular to the flow direction. In particular, the open cross-sectional area is the smallest area of the bypass device, oriented perpendicular to the flow direction, through which liquid flows. In particular, the open cross-sectional area determines the maximum volume flow, in particular the maximum flow rate, of liquid flowing through the bypass device.

In particular, the pressure washer is configured such that the bypass valve adjusts the size of the open cross-sectional area for a start-up phase of the motor after each start-up of the motor, independently of the degree of actuation of the control element, such that the bypass device establishes a liquid connection between the pressure chamber and the suction chamber. In this way, there is no need to measure pressure in the pressure chamber or take similar measures. Due to the fact that the bypass device is at least partially opened wide after each start-up of the motor, it is ensured that at least some of the liquid can be circulated between the pressure chamber and the suction chamber.

In particular, the pressure washer comprises a control unit. In particular, the control unit controls the bypass valve. In particular, the control unit controls the bypass valve at least in the start-up phase independently of the degree of actuation of the control element. To some extent, during the start-up phase of the motor, the control unit overrides a control signal transmitted from the control element to the control unit.

In particular, the start-up phase of the motor ends once a termination condition arises. In particular, the termination condition is met when a time interval, measured from the start-up of the motor, has expired. In particular, the motor is controlled by the control unit. In particular, the control unit measures the time interval. In particular, the time interval is 150 ms to 300 ms, in particular 200 ms to 250 ms. Due to the fact that the termination condition is defined by the expiration of a time interval, the start-up phase can be selected such that the motor achieves a sufficiently high rotational frequency or a sufficiently high torque during the start-up phase in order to be able to work against the back pressure in the pressure chamber after the start-up phase has finished.

Alternatively, it can also be provided that the termination condition arises when an initial volume threshold value for the volume flow of the liquid in the pressure chamber is reached. Instead of reaching an initial volume threshold value, reaching an initial pressure value of the liquid in the pressure chamber can also be provided. In particular, the volume flow in the pressure chamber is measured by means of a volume flow measurement device. In particular, the pressure in the pressure chamber is measured by means of a pressure measurement device.

In particular, the bypass valve adjusts the open cross-sectional area for the start-up phase of the motor in such a way that a pressure compensation between the pressure chamber and the suction chamber occurs through the bypass device, in particular through the bypass line. In particular, the bypass valve adjusts the open cross-sectional area for the start-up phase of the motor such that its size is maximal. In this way, the volume flow of liquid conveyed by the bypass device is maximal. The motor of the high-pressure pump must therefore work against the smallest possible pressure in the pressure chamber, at least in relation to the otherwise present conditions, such as the state of the main line valve, for example, which is arranged in particular in the pressure chamber between the high-pressure pump and a spray opening of the main line.

In particular, the size of the open cross-sectional area after the ending of the start-up phase, in particular in normal operation of the pressure washer, in particular when the main line valve is in a completely open state, depends, in particular initially, exclusively on the degree of actuation of the control element. In particular, a control signal generated by actuation of the control element after the start-up phase has ended, in particular in a normal operation of the pressure washer, is, in particular initially, no longer overridden by the control unit. After the start-up phase has ended, the pressure in the pressure chamber of the main line can be adjusted depending on the degree of actuation of the control element. This applies at least for the case in which the main line valve is in the completely opened state.

In particular, it is provided that, outside the start-up phase, the size of the open cross-sectional area at least does not increase, in particular decreases, as the degree of actuation of the control element increases. This applies in particular when the main line valve is in the completely opened state. In particular, the pressure in the pressure chamber of the main line increases or stays the same when the degree of actuation of the control element increases.

In particular, the bypass valve can be adjusted by means of a servomotor. In particular, the control unit sends a servomotor signal to the servomotor to adjust the size of the open cross-sectional area by means of the bypass valve.

According to the method for operating a pressure washer, it is provided that the size of the open cross-sectional area is adjusted by means of the bypass valve for a start-up phase of the motor independently of the degree of actuation of the control element in such a way that the bypass device establishes a liquid connection between the pressure chamber and the suction chamber. This is connected to the advantages described for the pressure washer.

In particular, the open cross-sectional area for the start-up phase of the motor is adjusted in such a way that its size is maximal. This is also connected to the advantages described for the pressure washer with regard to this feature.

The method for operating a pressure washer can be similarly developed around the optional features for the pressure washer described above. The corresponding development of the method is connected to the advantages of the various features described above.

A pressure washer is known from DE 10 2023 101 418 A1, in which a bypass device for fluid connection between the pressure chamber and suction chamber is provided between the pressure chamber and the suction chamber. To regulate the pressure in the pressure chamber, the open cross-sectional area of the bypass device can be adjusted by means of a bypass valve depending on a degree of actuation of a control element. Liquid can be conveyed through a main line by means of a high-pressure pump. The high-pressure pump can be driven by means of a motor. Furthermore, the pressure washer comprises a disconnecting device, by means of which the motor can be switched to the off-state. If the spraying out from the pressure chamber is prevented because the operator no longer presses the corresponding operating lever and the corresponding main line is closed, the pressure in the pressure chamber increases. This pressure acts on the disconnecting device. Due to the pressure present in the pressure chamber, the disconnecting device causes the motor to be in the off-state when the pressure in the pressure chamber corresponds to at least a pressure threshold value. This prevents the motor from permanently continuing to run when the main line valve is closed and prevents an increasingly greater pressure building up in the pressure chamber. In the case of a correspondingly larger open cross-sectional area of the bypass device, it could in principle occur that the pressure in the pressure chamber does not increase above the pressure threshold value after the main line is closed by means of the main line valve.

Consequently, the disconnecting device would not switch the motor to the off-state. The drive motor would then stay on and would circulate liquid via the bypass device. This would use energy and would cause unnecessary wear to the pressure washer. In order to avoid this, the bypass device from DE 10 2023 101 418 A1 comprises a pressure build-up valve. When a volume threshold value of the volume flow passing through the bypass device, in particular through the bypass line of the bypass device, is exceeded, the open cross-sectional area of the bypass device is reduced, due to the action of the pressure build-up valve, at least to such an extent that the pressure in the pressure chamber corresponds at least to the pressure threshold value. This ensures that the motor for driving the high-pressure pump is switched off when the main line is closed by means of the disconnecting device. However, the pressure build-up valve incurs costs and takes up installation space.

The object of the disclosure is to improve a pressure washer in such a way that a pressure regulation of the pressure in the pressure chamber is possible by adjusting the open cross-sectional area of the bypass device, and at the same time a low-wear and energy-efficient operation of the pressure washer is possible in a cost-effective and space-saving manner. This object is solved by a pressure washer as disclosed herein.

A further object of the disclosure is to specify a method by which a pressure regulation of the pressure in the pressure chamber is possible by adjusting the open cross-sectional area of the bypass device, and at the same time a low-wear and energy-efficient operation of the pressure washer is possible in a cost-effective and space-saving manner. This object is solved by a method as disclosed herein.

The pressure washer is configured such that the bypass valve, in particular a servomotor for the bypass valve, in particular a control unit for controlling the bypass valve, adjusts the size of the open cross-sectional area independently of an actuation of the control element, in particular a degree of actuation of the control element, to be at least so small, in particular reduces it to such an extent, that the pressure in the pressure chamber corresponds at least to the pressure threshold value when the main line valve is in the closed state and the motor is in the on-state at the same time. This ensures that the disconnecting device, due to the pressure in the pressure chamber exceeding the pressure threshold value, causes the motor to be switched to the off-state. In contrast to the prior art, no additional component such as a pressure switch-off valve is required for this purpose. The already present bypass valve can be used for this purpose. The bypass valve can be used as a pressure build-up valve. Due to the fact that no separate pressure build-up valve is required, costs and installation space can be saved.

Overall, the pressure washer is simple to construct. Even without a pressure build-up valve, it can be easily prevented, by making clever use of the already present bypass valve, that liquid is unnecessarily circulated. In this way, the components of the pressure washer are subjected to lower wear. The durability of the pressure washer is simply increased in a cost- and space-saving manner.

In particular, the liquid flows in a flow direction starting from the pressure chamber through the bypass device, in particular the bypass line and the bypass valve, towards the suction chamber. In particular, the open cross-sectional area is oriented perpendicular to the flow direction. In particular, the open cross-sectional area is the smallest surface of the bypass device oriented perpendicular to the flow direction through which liquid flows. In particular, the open cross-sectional area determines the maximum volume flow, in particular the maximum flow rate, of liquid flowing through the bypass device

In a development, it is provided that a flow of liquid through the bypass device is prevented by means of the bypass valve when the main line valve is in the closed state and the motor is simultaneously in the off-state. In other words, the size of the open cross-sectional area is zero. In this way, the pressure in the pressure chamber can build up in exactly the same way as if no bypass device were present when the main line valve is in the closed state and the motor is simultaneously in the on-state.

In a particular development, it is provided that the bypass valve, in particular the servomotor, in particular the control unit, adjusts the size of the open cross-sectional area independently of an actuation of the control element, in particular a degree of actuation of the control element, to be at least so small, in particular reduces it to such an extent, that the pressure in the pressure chamber corresponds at least to the pressure threshold value when the main line valve is in the transition from the completely opened state to the closed state and the motor is in the on-state at the same time. In other words, the bypass valve, in particular the servomotor, in particular the control unit, adjusts the size of the open cross-sectional area independently of the actuation, in particular the degree of actuation, of the control element already during the switching phase of the main line valve in such a way that the pressure in the pressure chamber corresponds to at least the pressure threshold value. In particular, the pressure washer is configured such that, in the case of maximum motor power or pump capacity and a completely closed bypass valve, the pressure in the pressure chamber is then above the pressure threshold value when the main line valve is not in its completely opened state. This enables the disconnecting device to switch the motor to the off-state even at a very early stage. This minimises the wear of the components of the pressure washer. It is reliably avoided that a very high pressure is built up in the pressure chamber. In particular, it is provided that the bypass valve adjusts the size of the open cross-sectional area independently of an actuation of the control element, in particular a degree of actuation of the control element, at least to be so small, in particular reduces it to such an extent, that the pressure in the pressure chamber corresponds to at least the pressure threshold value when the main line valve is not in the completely opened state and simultaneously the motor is in the on-state.

In particular, the disconnecting device is fluidically connected to the pressure chamber. This enables the pressure in the pressure chamber, in particular the liquid in the pressure chamber, to act upon the disconnecting device.

In particular, the size of the open cross-sectional area depends exclusively on the actuation of the control element, in particular the degree of actuation of the control element, when the main line valve is in the completely opened state. This applies at least in normal operation of the pressure washer, in particular after completion of a start-up phase of the motor for driving the high-pressure pump. In this way, the pressure in the pressure chamber of the main line can be easily adjusted by actuating the control element.

In particular, the pressure washer is configured such that the size of the open cross-sectional area, in particular in normal operation of the pressure washer, at least does not increase with an increasing degree of actuation of the control element, in particular decreases, when the main line valve is in the completely opened state. This enables an intuitive operation of the pressure washer. For working on areas that are to be washed with increased water pressure, the operator can extremely easily increase the pressure at short notice by pressing the control element more firmly (greater degree of actuation), and then in other areas, in which a lower pressure of the cleaning liquid is required, reduce it again by actuating the control element with less intensity (smaller degree of actuation). As a general rule: the more firmly the control element is pressed, in particular the greater the degree of actuation, the greater the pressure in the pressure chamber and thus also the pressure of the liquid sprayed out.

In particular, the bypass valve can be adjusted by means of the servomotor. This allows the open cross-sectional area of the bypass device, in particular of the bypass valve, to be easily adjusted. In particular, the open cross-sectional area of the bypass device can be adjusted to be at least so small, in particular to such an extent, by means of the servomotor that the pressure in the pressure chamber corresponds to at least the pressure threshold value when the main line valve is in its closed state and the motor is simultaneously in the on-state.

In particular, the pressure washer comprises the control unit. In particular, the pressure washer is configured such that the control unit contains information indicating whether the main line valve is in the closed or completely opened state. In particular, the control unit can also contain information indicating whether the main line valve is between the closed and the completely opened state. In particular, the pressure washer is configured such that the control unit contains information indicating whether the motor is in the on-state or in the off-state. In particular, a signal can be transmitted to the servomotor for the bypass valve by means of the control unit. Depending on the form and/or intensity of the signal, the servomotor adjusts the size of the open cross-sectional area of the bypass device. If the control unit contains information indicating that both the main line valve is in the closed state and the motor is in the on-state, the control unit sends a corresponding signal to the servomotor independently of an actuation of the control element, in particular a degree of actuation of the control element, whereby the servomotor adjusts the bypass valve in such a way that the size of the open cross-sectional area of the bypass device is so large that the pressure in the pressure chamber corresponds at least to the pressure threshold value.

In particular, the main line valve can be actuated by means of a valve control element. In particular, the main line valve can be switched between the completely opened state and the closed state by means of the valve control element. In particular, the pressure washer is configured such that the control unit contains information indicating whether the valve control element is actuated to such an extent that the main line valve is in the completely opened or the closed state. The information can also only include the state of the main line valve. Based on a piece of this information, the control unit can decide whether the size of the open cross-sectional area is adjusted independently of an actuation of the control element, in particular a degree of actuation of the control element.

In particular, the main line valve, when in the closed state, prevents liquid from flowing through the main line. In particular, when in the completely opened state, the main line valve allows the liquid to flow through the main line unimpeded.

In particular, the motor for driving the high-pressure pump has a switch for switching the motor between the on-state and the off-state. In particular, the disconnecting device has an actuating element. In particular, the pressure washer is configured such that the liquid in the pressure chamber acts on the actuating element in such a way that the actuating element actuates the switch of the motor in such a way that the motor is in the off-state when the pressure in the pressure chamber corresponds to at least the pressure threshold value. By means of the switch, the motor can easily be switched to the off-state when the pressure threshold value in the pressure chamber is exceeded.

In particular, the pressure washer has a pressure relief line. The pressure relief line fluidically connects the pressure chamber to the suction chamber, in particular in addition to the connection through the bypass device and the high-pressure pump. In particular, a pressure relief valve is arranged in the pressure relief line. The pressure relief valve is configured such that it opens when the pressure in the pressure chamber corresponds at least to the pressure threshold value. In this way, a pressure compensation between the pressure chamber and the suction chamber can occur. This is in particular possible when the motor has already been switched to the off-state. The pressure compensation between the pressure chamber and the suction chamber protects the components of the pressure washer. This increases the operating life of the pressure washer. A low-wear operation of the pressure washer is enabled. The pressure relief valve has a valve member. In particular, the valve member can be moved together with the actuating element. In this way, components and installation space can be saved. Due to the fact that the pressure washer is designed in such a way that when the valve member moves due to the pressure acting on the valve member in the pressure chamber, the actuating element is also moved, a simple construction of the pressure washer is possible.

In particular, the pressure washer is configured such that the disconnecting device is only impinged upon with a single pressure value of the pressure chamber. In this way, a simple design of the pressure washer is possible. In particular, a complicated design based on a pressure impingement of the disconnecting device on one side with an injector pressure and on the other side with the pressure value in the pressure chamber upstream of the venturi can be avoided.

In particular, the pressure washer comprises a check valve. In particular, the check valve is arranged in the pressure chamber downstream of the bypass device, in particular the bypass line, and upstream of the disconnecting device. This has the effect that the pressure on the disconnecting device can only increase as long as the motor for driving the high-pressure pump is running and the main line valve is in the closed state. This can also have the effect that the pressure on the pressure relief valve can only increase as long as the motor for driving the high-pressure pump is running and the main line valve is in the closed state. In this way, a condition is fulfilled so that the pressure in the pressure chamber exceeds the pressure threshold value and the disconnecting device switches the motor to the off-state. It can also be achieved that the pressure in the pressure chamber exceeds the pressure threshold value and the pressure relief valve opens.

According to the method for operating a pressure washer, it is provided that, independently of an actuation, in particular a degree of actuation, of the control element by means of the bypass valve, the size of the open cross-sectional area is adjusted to be at least so small, in particular reduced to such an extent, that the pressure in the pressure chamber corresponds to at least the pressure threshold value when the main line valve is in the closed state and the motor is simultaneously in the on-state. This is associated with the advantages described with regard to the pressure washer.

The method for operating a pressure washer can be developed in a similar manner around the optional features described above for the pressure washer. The corresponding development of the method is associated with the advantages described above in relation to the various features.

### BRIEF DESCRIPTION OF THE DRAWINGS

Exemplary embodiments of the invention are explained below using the drawing. Here are shown:

FIG. 1: a perspective depiction of a pump unit of a pressure washer,

FIGS. 2 and 3: perspective depictions of a spray unit, which can be handheld, of the pressure washer,

FIG. 4: a side view of the spray unit, which can be handheld, according to FIGS. 2 and 3,

FIG. 5: a schematic depiction of a pressure washer having a bypass device with a bypass valve for regulating the pressure in the pressure chamber of the main line of the pressure washer by means of a pressure control element, wherein both the pressure control element and a valve control element in FIG. 5 are not actuated,

FIG. 6: a schematic depiction of the pressure washer from FIG. 5 with an actuated valve control element and an unactuated pressure control element,

FIG. 7: a schematic depiction of the pressure washer from FIG. 5 with an actuated valve control element and an actuated pressure control element, and

FIG. 8: a hydraulic circuit diagram of the pressure washer from FIG. 5.

### DETAILED DESCRIPTION

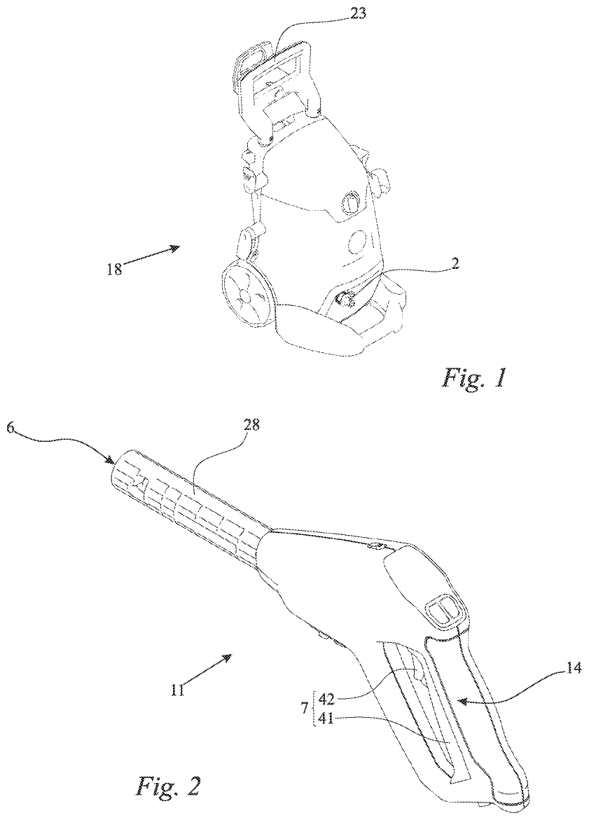

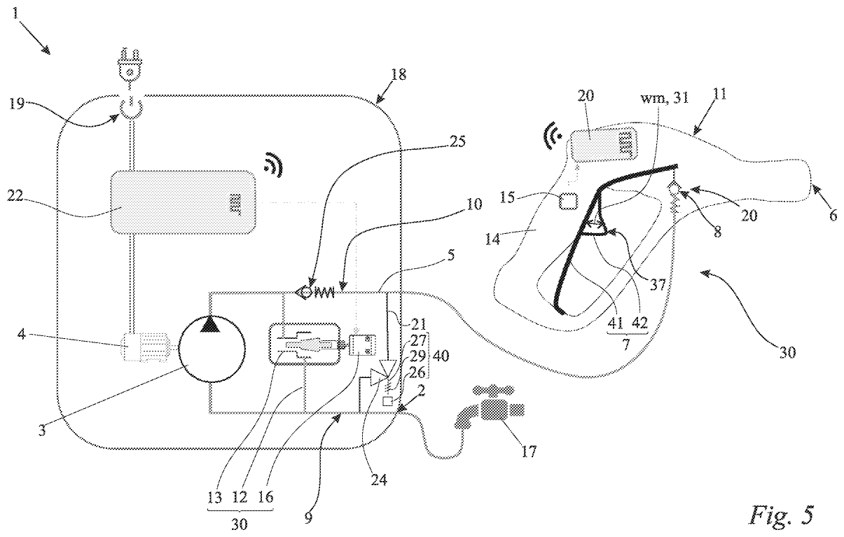

FIG. 1 shows a pump unit 18 of a pressure washer 1 depicted schematically in FIG. 5.

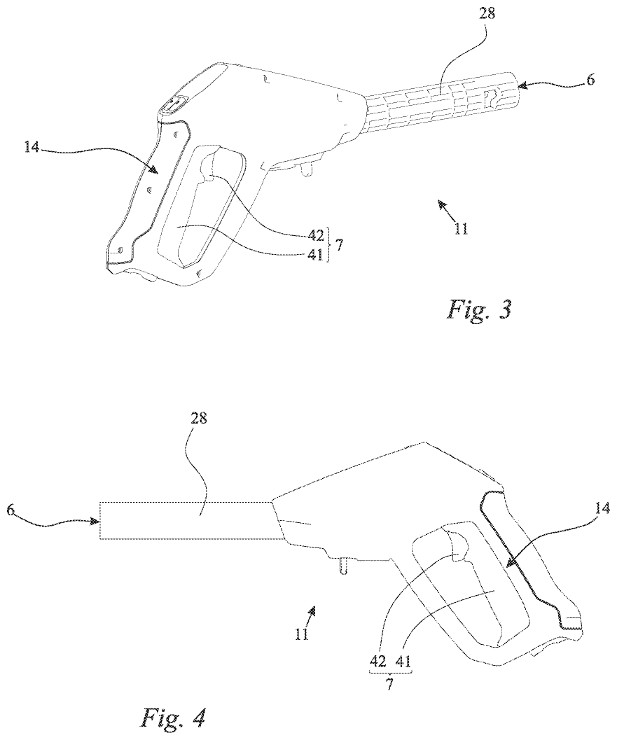

The pressure washer 1 comprises a spray unit 11. The spray unit 11 can, as depicted in FIGS. 5 to 7, be formed as a gun. A spray opening 6 is arranged on the gun. Alternatively, the spray unit 11 can also be formed as a gun with a lance 28, as depicted in FIGS. 2 to 4. In this case, the spray opening 6 is arranged on the lance 28.

The pressure washer 1, in particular the spray unit 11, is configured to clean objects with pressurised cleaning liquid. In the exemplary embodiments, the pressure washer 1 is portable. The pressure washer 1, in particular the pump unit 18, has a handle 23 depicted in FIG. 1. The pressure washer 1, in particular the pump unit 18 of the pressure washer 1, can be carried by the handle 23. In intentional operation, it is provided that the pressure washer 1, in particular the pump unit 18, is placed on a support surface.

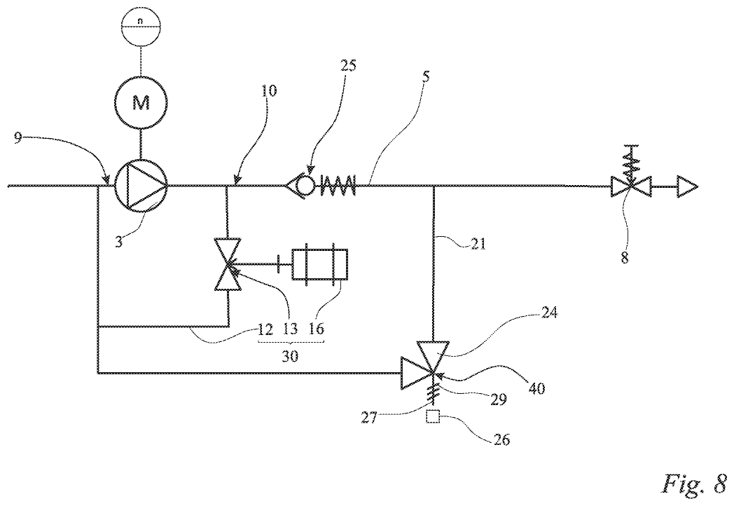

As is depicted in FIGS. 5 to 8, the pressure washer 1 has a high-pressure pump 3. The high-pressure pump 3 is a component of the pump unit 18. By means of the high-pressure pump 3, liquid can be pressurised in the pressure washer 1, in particular in the pump unit 18. The liquid is in particular water, in particular a mixture of water and an additive. The additive is in particular a cleaning solution, in particular a soap solution. In particular, the cleaning agent is liquid. By means of the high-pressure pump 3, the liquid can be pressurised by at least 10 bar, in particular at least 15 bar, in particular at least 30 bar, in particular at least 100 bar. In particular, the liquid can be pressurised by the high-pressure pump 3 with a pressure of a maximum of 600 bar, in particular a maximum of 500 bar. The high-pressure pump 3 comprises at least one piston, which is not depicted. The at least one piston can be moved back and forth to exert pressure on the liquid. Typically, the high-pressure pump 3 comprises three pistons.

As is depicted in FIGS. 1 and 5 to 7, the pressure washer 1, in particular the pump unit 18, comprises a port 2 for a liquid source 17. In the exemplary embodiments, the liquid source 17 is an external liquid source. In the exemplary embodiments, the external liquid source is the tap of a domestic water supply system. It can also be provided that the liquid source is an integral component of the pressure washer 1. The pressure washer 1, in particular the spray unit 11 which can be handheld, comprises a spray opening 6.

As is depicted in FIGS. 5 to 7, the pump unit 18 and the spray unit 11 are fluidically connected to each other via a main line 5. The pressure washer 1 comprises the main line 5. The main line 5 fluidically connects the port 2 to the spray opening 6. The port 2 is arranged on the pump unit 18. The spray opening 6 is arranged on the spray unit 11. In the exemplary embodiment according to FIGS. 2 to 4, the spray opening 6 is arranged on a lance 28 of the spray unit 11. In the exemplary embodiment according to FIGS. 5 to 7, the spray opening 6 is arranged on the spray unit 11 formed as a gun.

By means of the high-pressure pump 3, liquid can be conveyed through the main line 5 from the port 2 to the spray opening 6. The liquid source 17 supplies liquid to the main line 5. The high-pressure pump 3 is arranged in the main line 5. The high-pressure pump 3 pressurises the liquid. The high-pressure pump 3 is arranged between a suction chamber 9 and a pressure chamber 10 of the main line 5. This is depicted in FIGS. 5 to 8. The main line 5 has the suction chamber 9 between the port 2 and the high-pressure pump 3. The main line 5 has the pressure chamber 10 between the high-pressure pump 3 and the spray opening 6. In the exemplary embodiments, the suction chamber 9 is formed by a section of the main line 5 between the port 2 and the high-pressure pump 3. In the exemplary embodiments, the pressure chamber 10 is formed by a section of the main line 5 between the high-pressure pump 3 and the spray opening 6. This section of the main line 5 extends in particular precisely from the high-pressure pump 3 to precisely the spray opening 6. The high-pressure pump 3 conveys liquid from the suction chamber 9 to the pressure chamber 10. In the pressure chamber 10, there is a higher pressure when the high-pressure pump 3 is in operation than in the suction chamber 9. The suction chamber 9 and the pressure chamber 10 are components of the main line 5. There is a higher pressure in the main line 5 downstream of the high-pressure pump 3 than upstream of the high-pressure pump 3.

The high-pressure pump 3 is arranged in the pump unit 18. The high-pressure pump 3 is formed separately from the spray unit 11. Various spray units 11 can be connected to the high-pressure pump 3. To drive the high-pressure pump 3, the pressure washer 1 has a motor 4. The motor 4 is arranged in the pump unit 18. The motor 4 can be formed as a brushless DC motor. A brushless DC motor is also referred to as an EC motor. The motor can also be a universal motor. In the exemplary embodiments, the motor 4 is an induction motor. In an induction motor, a rotating magnetic field of the stator sets the rotor in motion. The induction motor in the exemplary embodiments is operated with alternating current. The voltage source can, for example, be made available by the mains voltage. If battery operation is provided, the motor can also be a brushless DC motor. It can then be provided that the battery is a component of the pressure washer 1. In particular, it can then be provided that the pump unit is a component of the spray unit 11, which can be handheld. In this case, the entire pressure washer 1 is portable in operation and can be guided by hand. In particular, the pump unit and the spray unit are then formed integrally. In particular, the pump unit and the spray unit are then arranged in a common housing. In particular, the pump unit and the spray unit are then connected to each other rigidly, in particular not by means of a flexible tube. In particular, the main line 5 is then arranged in a single housing.

As is depicted in FIGS. 5 to 7, the pressure washer 1 comprises a main switch 19. The main switch 19 serves to cut off the power supply of the entire pressure washer 1. The main switch 19 is arranged on the pump unit 18.

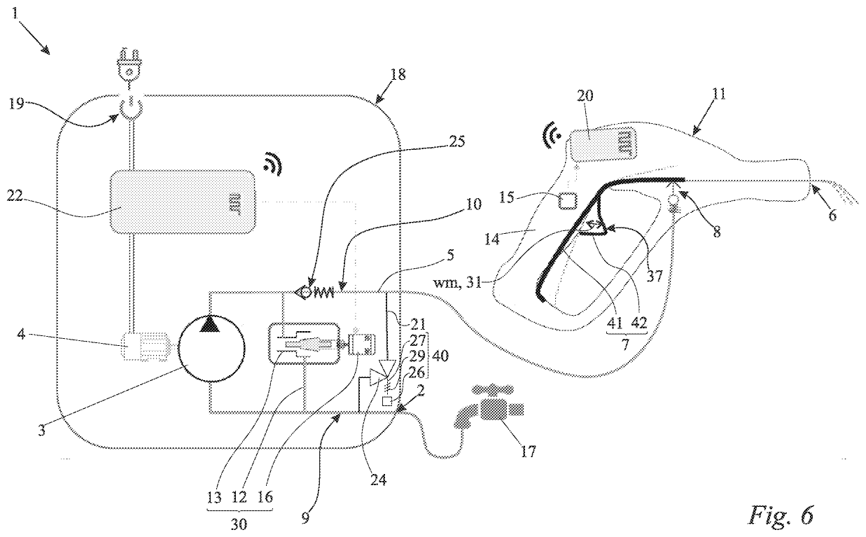

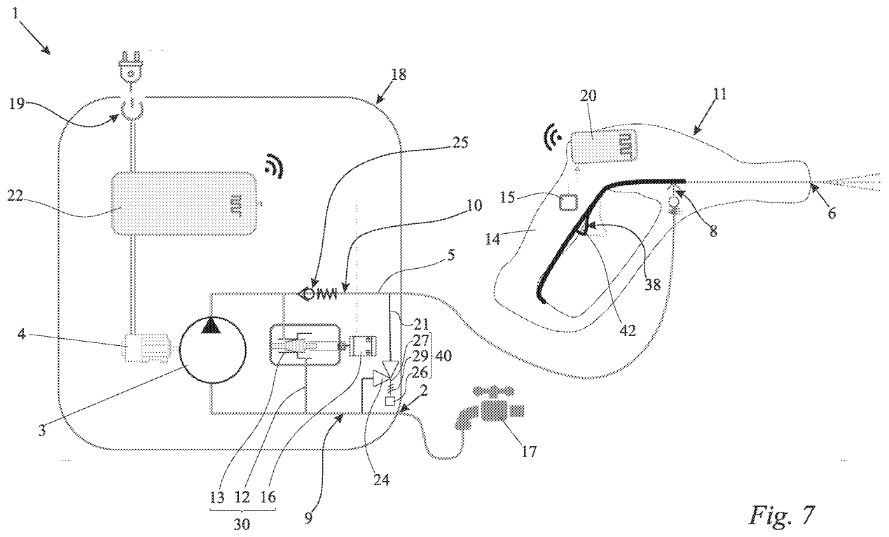

The pressure washer 1 comprises a main line valve 8. The main line valve 8 is arranged in the main line 5. In the exemplary embodiments, the main line valve 8 is arranged in the spray unit 11. The main line valve 8 has a closed state and a completely opened state. In the completely opened state, the main line valve 8 enables liquid to flow through the main line 5, in particular unimpeded. The completely opened state of the main line valve 8 is depicted in FIGS. 6 and 7. In the completely opened state, the flow cross-section of the main line 5 located in the position of the main line valve 8 is at its maximum. A further opening of the main line valve 8 does not lead, in its completely opened state, to a greater flow cross-section for the liquid in the main line 5 in the position of the main line valve 8. In the closed state of the main line valve 8, the main line valve 8 prevents liquid from flowing through the main line 5, in particular completely. In the completely opened state of the main line valve 8, liquid is sprayed out of the spray opening 6 during operation, in particular normal operation, of the pressure washer 1. In the closed state of the main line valve 8, no liquid is sprayed out of the spray opening 6. In the exemplary embodiments, the main line valve 8 is arranged between the high-pressure pump 3 and the spray opening 6.

The pressure washer 1 comprises the bypass device 30 depicted in FIGS. 5 to 7. By means of the bypass device 30, the pressure in the main line 5, in particular in the pressure chamber 10, can be influenced, in particular can be changed, in particular can be adjusted.

The pressure washer 1, in particular the spray unit 11, has a control device 7. The control device 7 is formed separately from the main switch 19. The bypass device 30 can be controlled by means of the control device 7.

In particular, the main line valve 8 can be switched between the completely opened state and the closed state by means of the control device 7. In the exemplary embodiments, the control device 7 is arranged on the spray unit 11.

The control device 7 generates a control signal which is dependent on an actuation, in particular a degree of actuation, of the control device 7. Based on the control signal, the bypass device 30 adjusts the liquid volume flow, in particular the pressure, of the liquid in the main line 5, in particular in the pressure chamber 10.

In the exemplary embodiments, the control device 7 has a valve control element 41 and a control element 42. The valve control element 41 serves to actuate the main line valve 8, in particular to switch between the closed state and the completely opened state. The control element 42 serves to actuate the bypass device 30. As an alternative to the exemplary embodiments, it can also be provided that the control device 7 consists of one single control element, which serves to actuate the main line valve 8 as well as to actuate the bypass device 30. By way of example, it can be provided that the single control element can be shifted along a travel path. When the control element is first actuated, the main line valve 8 is opened first and, after travelling along part of the travel path, the bypass device 30 is then actuated and the liquid volume flow, in particular the pressure, in the main line 5, in particular in the pressure chamber 10, is changed, in particular adjusted. Depending on the degree of actuation, i.e. depending on how large the travelled part of the travel path is, the bypass device 30 adjusts the liquid volume flow, in particular the pressure, in the main line 5, in particular in the pressure chamber 10. In particular, the single control element generates a control signal which is dependent on the degree of actuation of the control element, on the basis of which control signal the bypass device 30 adjusts the liquid volume flow, in particular the pressure, in the main line 5, in particular in the pressure chamber 10.

In the exemplary embodiments, the control device 7 comprises the control element 42 and the valve control element 41. The control element 42 can be controlled independently of the valve control element 41. The pressure washer 1, in particular the spray unit 11, is configured such that the valve control element 41 can be actuated without an actuation of the control element 42. It can be provided that the pressure washer 1, in particular the spray unit 11, is configured such that the control element 42 can be actuated without the valve control element 41 being actuated simultaneously. However, such a coupling can also be provided. In particular, it can be provided that the control element 42 can be mechanically pressed without the valve control element 41 being pressed simultaneously. In the exemplary embodiments, the pressure washer 1 is configured such that the control element 42 does not trigger a function when actuated without simultaneous actuation of the valve control element 41. Here, there is at least no change in the liquid volume flow, in particular in the pressure, in the main line 5 triggered by the control element 42, and in particular not by the bypass device 30. This separation of mechanical actuation and functional release occurs by means of control technology.

The main line valve 8 can be switched between the completely opened state and the closed state by means of the valve control element 41. By means of the control element 42, the liquid volume flow, in particular the pressure, of the liquid in the pressure chamber 10 can be influenced, in particular can be changed, in particular can be set. This is in particular the case in the completely opened state of the main line valve 8.

As is depicted in FIGS. 5 to 8, the bypass device 30 comprises a bypass line 12, a bypass valve 13 and in particular a servomotor 16. The bypass device 30 serves to fluidically connect the pressure chamber 10 and the suction chamber 9. By means of the bypass device 30, a further fluid connection between the suction chamber 9 and the pressure chamber 10 separate from the fluid connection of the suction chamber 9 with the pressure chamber 10 via the high-pressure pump 3 is possible.

The bypass valve 13 is in particular arranged between two sections of the bypass line 12. In particular, the bypass valve 13 is arranged in the bypass line 12. The bypass valve 13 serves to regulate the pressure in the pressure chamber 10. By means of the bypass valve 13, the size of the open cross-sectional area of the bypass device 30 can be adjusted. When the high-pressure pump 3 is in operation, there is a higher pressure in the pressure chamber 10 than in the suction chamber 9. When the bypass valve 13 is opened, due to this pressure gradient, liquid can flow from the pressure chamber 10 into the suction chamber 9 through the bypass device 30, in particular through the bypass line 12 and the bypass valve 13. By adjusting the open cross-sectional area of the bypass device 30 by means of the bypass valve 13, the pressure in the pressure chamber 10 can be regulated. In the case of a larger open cross-sectional area, the pressure compensation between the pressure chamber 10 and the suction chamber 9 occurs to a greater extent. If there is to be a high pressure in the pressure chamber 10, the open cross-sectional area of the bypass device 30 is reduced by means of the bypass valve 13. The larger the open cross-sectional area of the bypass device 30, in particular of the bypass valve 13, the larger the liquid volume flow through the bypass device 30, in particular through the bypass valve 13, in operation under otherwise unchanged conditions.

The bypass valve 13 can be adjusted between a completely closed state and a completely opened state stepwise or steplessly. The bypass valve 13 can have different degrees of closure between the completely closed state and the completely opened state. In the exemplary embodiments, the bypass valve 13 can be continually adjusted at least in sections. It can also be provided that the bypass valve can be continually adjusted without interruption between the completely closed state and the completely opened state. The bypass valve 13 can be adjusted by means of the servomotor 16. The servomotor 16 is arranged in the pump unit 18. By means of the servomotor 16, the bypass valve 13 can be adjusted in such a way that the open cross-sectional area of the bypass device 30 can be adjusted.

The control device 7, in particular the control element 42, generates the control signal dependent on an actuation, in particular a degree of actuation of the control device 7, in particular of the control element 42. In particular, the bypass valve 13 can be actuated depending on the control signal generated by the control element 42, in particular with regard to its intensity and/or form. In particular, the degree of closure of the bypass valve 13 depends on the control signal, in particular the intensity and/or the form of the control signal. The bypass device 30 adjusts the pressure, in particular the liquid volume flow, in the main line 5, in particular in the pressure chamber 10, based on the control signal. The pressure, in particular the liquid volume flow, can be influenced, in particular can be changed, in particular can be adjusted, by means of the control element 42 in such a way that the magnitude of the pressure, in particular of the liquid volume flow, can take on at least three different values. It can also be provided that the magnitude of the liquid volume flow can be adjusted, in particular can be set, quasi-continuously, in particular continuously, by means of the control element 42.

The magnitude of the pressure, in particular of the liquid volume flow, in the pressure chamber 10 can be influenced, in particular can be changed, in particular can be adjusted, depending on the degree of actuation of the control element 42.

In the unactuated state, the control element 42 is in a rest position 37 depicted in FIG. 6. The control element 42 can be adjusted along a travel path 31, in particular into different adjustment positions. The travel path 31 is limited by the rest position 37 and an end position 38 depicted in FIG. 7. The control element 42 is pre-tensioned into the rest position 37.

The pressure washer 1 is configured such that the bypass valve 13 adjusts the size of the open cross-sectional area of the bypass device 30 depending on the adjustment position of the control element 42. Depending on the adjustment position of the control element 42, the control element 42 generates the control signal. By means of the control element 42, various control signals can be generated. Based on the control signal, the bypass device 30 adjusts the pressure, in particular the liquid volume flow, in the main line 5, in particular in the pressure chamber 10.

In particular, the size of the open cross-sectional area can be adjusted by means of the control element 42 in at least three, in particular at least six, in particular in at least ten stages. It can also be provided that the size of the open cross-sectional area can be continuously adjusted by means of the control element. In the exemplary embodiments, the size of the open cross-sectional area can be adjusted by means of the control element 42, in particular in a maximum of 30, in particular in a maximum of 20, stages. In the exemplary embodiments, the size of the open cross-sectional area can be quasi-continuously adjusted by means of the control element 42. In the present case, “quasi-continuously” is to be understood to mean that the various pressure stages, in particular the various liquid volume stages, are so close to each other that it appears to the user as though the pressure, in particular the liquid volume flow, is continuously adjusted when he/she actuates the control element 42.

Depending on the degree of closure of the bypass valve 13, the pressure, in particular the volume flow of the liquid in the main line 5, in particular in the pressure chamber 10, can be adjusted. The more the bypass valve 13 is closed, the smaller the open cross-sectional area of the bypass device 30. The more the bypass valve 13 is closed, the greater the pressure, in particular the volume flow, of the liquid in the main line 5, in particular in the pressure chamber 10. The more the bypass valve 13 is closed, the greater the pressure, in particular the volume flow, of the liquid in the main line 5, which is present at the spray opening 6.

The bypass valve 13 can be adjusted by means of the control device 7, in particular by means of the control element 42, in particular based on the control signal. In the exemplary embodiments, the control element 42 serves to adjust the open cross-sectional area of the bypass device 30. By adjusting the bypass valve 13, the pressure, in particular the liquid volume flow, in the main line 5, in particular in the pressure chamber 10, in particular at the spray opening 6, can be regulated.

By means of the control device 7, both the main line valve 8 can be switched between the completely opened state and the closed state, and the pressure, in particular the liquid volume flow, in the main line 5, in particular in the pressure chamber 10, can be preset, in particular adjusted.

The spray unit 11 is moveable relative to the pump unit 18. In the exemplary embodiments, the main line 5 is formed as a flexible tube between the pump unit 18 and the spray unit 11. The spray opening 6 is arranged on the spray unit 11. The spray unit 11 can be directed towards an object to be cleaned with its spray opening 6. The spray unit 11 can be handheld. The control device 7 is arranged on the spray unit 11. A user can guide the spray unit 11 by hand and can simultaneously control the control device 7 with the same hand.

The control device 7 is pretensioned in an unactuated state. Both the valve control element 41 and the control element 42 are pretensioned independently of each other in an unactuated state. A spring, not depicted in the figures, can serve for this purpose in each case.

The main line valve 8 can be transferred from the completely closed state to the completely opened state by actuating the valve control element 41.

The control element 42 can be adjusted along the travel path 31 depicted in FIG. 5. The travel path 31 is also referred to as an adjustment region. Within the adjustment region, the control element 42 can occupy different adjustment positions, in particular depending on the degree of actuation of the control element 42. It can be provided that the control element 42 can exclusively be adjusted in a stepwise manner. In the exemplary embodiments, the control element 42 can be continuously adjusted within the adjustment region into different adjustment positions.

The pressure washer 1 comprises a detector 15. The detector 15 is schematically depicted in FIGS. 5 to 7. The detector 15 is configured to detect the adjustment position, in particular the degree of actuation of the control device 7, in particular of the control element 42 of the control device 7. The detector can detect any continuous adjustment position of the control device 7, in particular of the control element 42, within the adjustment region, in particular along the travel path 31. It can be provided that the detector 15 is a Hall effect sensor. In the exemplary embodiments, the detector 15 is a potentiometer. The control device 7, in particular the control element 42, and the detector 15 are arranged on the spray unit 11 in such a way that the detection of the adjustment position of the control device 7, in particular of the control element 42, is possible. The control element 42 interacts at least indirectly with the detector 15. In the exemplary embodiments, a mechanical connection element is arranged between the detector 15 and the control device 7, in particular the control element 42. The mechanical connection element couples the control device 7, in particular the control element 42, and the detector 15 together. By means of the mechanical connection element, the control device 7, in particular the control element 42, interacts with the detector 15.

The control signal is generated by means of the detector 15. The control signal is generated indirectly by means of the control device 7, in particular the control element 42. In particular, the control signal is generated indirectly depending on the actuation, in particular the degree of actuation, of the control device 7, in particular of the control element 42. The control signal can, however, also be another signal which is generated on the signal path between the control device 7 and the bypass device 30.

As is depicted in FIGS. 5 to 8, the control element 42 can be adjusted along the travel path 31, in particular in the adjustment region of the control element 42, from the rest position 37 into adjustment positions with increasing distance from the rest position 37. The control element 42 is at the maximum distance from the rest position 37 when it is in the end position 38. In the end position 38, the control element has travelled the maximum travel path. The pressure washer 1 is configured such that control signals with higher or lower intensity are generated with increasing distance of the control element 42 from the rest position 37. In the exemplary embodiments, the intensity of the control signals increases with increasing distance between the control element 42 and the rest position 37. The control signal, in particular the intensity of the control signal, depends on the degree of actuation of the control element 42. With increasing intensity of the control signals, the bypass device 30 adjusts a higher or at least no lower pressure, in particular liquid volume flow, in the main line 5, in particular in the pressure chamber 10. When the control element 42 is in the end position 38, it, in particular the detector 15, generates a control signal of maximum intensity. Then a maximum possible pressure, in particular liquid volume flow, is adjusted in the main line 5, in particular in the pressure chamber 10, by means of the bypass device 30.

The distance from the rest position 37 refers to the distance of a reference point on the control element 42 from the rest position 37. In the exemplary embodiments, the control element 42 is a pivot lever, which can be pivoted about a control element pivot axis. In the exemplary embodiment, the reference point is the point of the control element 42 having the greatest distance from the control element pivot axis. In the exemplary embodiments, the rest position 37 is defined by the position of the reference point in the case of an unactuated control element 42.

When the control element 42 formed as a pivot lever is actuated in the rest position 37 of the control element 42, the control element 42—and thus also the reference point—is pivoted along the travel path 31, in particular within the adjustment region. In this case, the travel path 31 is a circular segment. The distance between the control element 42 and the rest position 37 corresponds to the distance of the reference point from the rest position 37 measured along the travel path 31 formed as a circular segment. The reference point moves with regard to the pivot movement about the control element pivot axis on a circular path. It can also be provided to measure the distance in the form of an angular distance of the reference point from the rest position with regard to a pivot movement about the control element pivot axis.

In the exemplary embodiments, the valve control element 41 is a pivot lever which can be pivoted about a valve control element pivot axis. In particular, the valve control element 41 is mounted in a pivotable manner about the valve control element pivot axis in the spray unit 11, in particular in a housing of the spray unit 11.

The pressure washer 1 has a control unit 22 depicted in FIGS. 5 to 7. The control unit 22 is arranged in the pump unit 18. It can also be provided that the control unit 22 is arranged in the spray unit 11. The signal generated by the detector 15, in particular the control signal, is directly or indirectly transmitted to the control unit 22, in particular in the form of a wireless, in particular electromagnetic, signal, in particular transmitted via a radio path. In the exemplary embodiments, this occurs by means of the transmitter unit 20. The transmitter unit 20 is arranged on, in particular in, the spray unit 11. The signal received by the control unit 22 is then used to influence, in particular to change, in particular to adjust, the pressure, in particular the liquid volume flow, in the main line 5, in particular in the pressure chamber 10, in particular by means of the bypass device 30. In particular, a pressure signal, in particular with a specific intensity and/or form, is generated by the control unit 22 based on the control signal received by the control unit 22, and is transmitted to the bypass device 30, in particular wirelessly and/or in a wired manner to the bypass device 30, in particular the servomotor 16.

The motor 4 of the pressure washer 1 has an on-state and an off-state. In the on-state, the motor 4 is driven, in particular supplied with electrical power. In the off-state, the motor 4 is not driven, in particular is not supplied with electrical power. As is depicted in FIGS. 5 to 8, the motor 4 has a switch 26. The switch 26 serves to switch the motor 4 between the on-state and the off-state.

As is depicted in FIGS. 5 to 8, the pressure washer 1 comprises a disconnecting device 40. The motor 4 can be brought into the off-state by means of the disconnecting device 40. The disconnecting device 40 has an actuating element 27. The switch 26 of the motor 4 can be actuated by means of the actuating element 27. The switch 26 is a component of the disconnecting device 40.

The disconnecting device 40 serves to transfer the motor 4 into the off-state. The pressure washer 1 is configured such that the disconnecting device 40 causes, due to the pressure in the pressure chamber 10, the motor 4 to be in the off-state when the pressure in the pressure chamber corresponds to at least a pressure threshold value. In particular, the pressure washer 1 is configured such that the liquid in the pressure chamber 10 has such an effect on the actuating element 27 of the disconnecting device 40 that the actuating element 27 actuates the switch 26 of the motor 4, in particular of the disconnecting device 40, in such a way that the motor 4 is in the off-state when the pressure in the pressure chamber 10 corresponds to at least the pressure threshold value.

As is depicted in FIGS. 5 to 8, the pressure washer 1 comprises a pressure relief line 21. The pressure relief line 21 fluidically connects the pressure chamber 10 to the suction chamber 9. By means of the pressure relief line 21, a further fluid connection between the suction chamber 9 and the pressure chamber 10 separate from the fluid connection between the suction chamber 9 and the pressure chamber 10 via the high-pressure pump 3 and separate from the bypass device 30 is possible.

In the exemplary embodiments, the disconnecting device 40 is fluidically connected to the pressure chamber 10. The pressure in the pressure chamber 10 can act on the disconnecting device 40. In particular, the disconnecting device 40 is arranged, in particular at least partially, in the pressure relief line 21. In particular, the actuating element 27 is moveably mounted in the pressure relief line 21. In particular, the actuating element 27 is moveable due to the pressure in the pressure chamber 10, in particular in the pressure relief line 21, in particular due to the liquid.

The pressure relief line 21 can be closed or opened. A pressure relief valve 24 is arranged in the pressure relief line 21. The pressure relief valve 24 is configured such that it opens when the pressure in the pressure chamber 10 corresponds to at least a pressure threshold value.

The pressure washer 1 comprises a check valve 25, as is depicted in FIGS. 5 to 8. The check valve 25 is arranged in the pressure chamber 10. The check valve 25 is arranged downstream of the bypass device 30, in particular of the bypass line 12, in the pressure chamber 10. The check valve 25 is arranged upstream of the disconnecting device 40, in particular upstream of the pressure relief line 21, in particular of the branch point of the pressure relief line out of the pressure chamber 10.

When the motor 4 is in the on-state, the high-pressure pump 3 conveys a volume flow of liquid through the main line 5. In the open state, the main line valve 8 allows liquid to pass through the main line 5. When the main line valve 8 is in the closed state, liquid can no longer be conveyed through the main line 5. Immediately after closing the main line valve 8, no volume flow of the liquid conveyed by the high-pressure pump 3 can reach the spray opening 6. Conveying the liquid by means of the high-pressure pump 3 is now no longer required. The motor 4 for driving the high-pressure pump 3 is to be brought into the off-state. The disconnecting device 40 is provided for this purpose.

When the bypass device 30 is closed and the main line valve 8 has been transferred into the closed state, the high-pressure pump 3 continues to convey liquid into the pressure chamber 10. Due to the check valve 25, the liquid cannot flow out of the pressure chamber 10 again. The pressure in the pressure chamber 10 increases, and at some point the pressure threshold value is reached. When the pressure in the pressure chamber 10 corresponds at least to the pressure threshold value, the disconnecting device 40 causes the motor 4 to be in the off-state due to the pressure in the pressure chamber 10. Then, the high-pressure pump 3 is no longer unnecessarily driven by means of the motor 4. Energy can be saved and the wear on the pressure washer 1 can be kept low.

The pressure washer 1 is configured such that the disconnecting device 40 switches the motor 4 into the off-state when or after the main line valve 8 is transferred from the open state into the closed state. The pressure of the liquid in the pressure chamber 10 exerts a force onto the actuating element 27. In particular, the disconnecting device 40, in particular the actuating element 27 in an unactuated state of the disconnecting device 40, in particular of the actuating element 27, is pretensioned. In particular, the pressure of the liquid in the pressure chamber 10 exerts a force on the actuating element 27 which counteracts the force of a spring 29. The spring 29 is a component of the disconnecting device 40. In the exemplary embodiments, the disconnecting device 40 comprises the actuating element 27, the switch 26 and the spring 29. The spring 29 pretensions the disconnecting device 40, the actuating element 27 in the exemplary embodiment, into the unactuated state of the disconnecting device 40, in particular of the actuating element 27, in particular of the switch 26 of the motor 4. In order to actuate the switch 26, a force must be applied by the liquid in pressure chamber which moves the actuating element 27 against the force of the spring 29 in the direction of the switch 26. When the pressure of the liquid in the pressure chamber 10 exerts a force on the actuating element 27 which is greater than the force of the spring 29, the actuating element 27 is moved towards the switch 26. The switch 26 is actuated. In this way, the motor 4 is transferred into the off-state. Consequently, liquid is no longer conveyed by the high-pressure pump 3 into the pressure chamber 10.

The pressure relief valve 24 has a valve member. In the exemplary embodiments, the valve member can be moved together with the actuating element 27. This results in a particularly simple and space-saving design of the pressure relief valve 24 and the disconnecting device 40. The disconnecting device 40 is subjected to only a single pressure value of the pressure chamber 10 at any given time. On the other side of the disconnecting device 40, the pressure of the suction chamber 9 is present. This results in a simple constructive design of the disconnecting device 40.

In the exemplary embodiments, the pressure relief valve 24 opens when the pressure threshold value in the pressure chamber 10 is exceeded. The pressure threshold value is also referred to as a pressure relief threshold value. When the pressure in the pressure chamber 10 in the region between the check valve 25 and the main line valve 8 corresponds at least to the pressure threshold value, the pressure relief valve 24 is opened and the motor 4 is in the off-state due to the pressure in the pressure chamber 10. In the exemplary embodiments, the pressure washer 1 is configured such that the pressure in the pressure chamber 10 corresponds at least to the pressure relief threshold value after the main line valve 8 has been switched from the open state to the closed state, in particular when the main line valve 8 is in the transition from the completely opened state to the closed state, in particular when the main line valve 8 is not in the completely opened state. The pressure increase in the pressure chamber 10 occurs since the high-pressure pump 3 continues to convey liquid into the pressure chamber 10 and the main line valve 8 continues to be closed. Firstly, the valve member of the pressure relief valve 24 must be moved out of a rest position. For this purpose, a higher pressure is required than afterwards for the sliding of the valve member into an opened position of the pressure relief valve 24. Therefore, once the main line valve 8 has been closed, pressure builds up initially which is higher than the pressure that is subsequently required in order to keep the motor 4 in the off-state by means of the disconnecting device 40. The pressure value in the pressure chamber 10 that is required to keep the motor 4 in the off-state by means of the disconnecting device 40 is referred to as the motor retaining value. The pressure threshold value is greater than the motor retaining value. Exemplary embodiments are also conceivable in which the pressure threshold value corresponds to the motor retaining value. In particular, a design without a pressure relief valve can also be provided. When the pressure threshold value then corresponding to the motor retaining value is exceeded, then only the motor is switched to the off-state. A pressure relief of the pressure chamber is not provided in such exemplary embodiments. In the exemplary embodiments, after the pressure threshold value in the pressure chamber 10 is exceeded, liquid can flow back from the pressure chamber 10 into the suction chamber 9 through the pressure relief line 21 due to the opening of the pressure relief valve 24, as is depicted in FIGS. 5 to 8. This ensures a partial pressure compensation between the pressure chamber 10 and the suction chamber 9.

As soon as the pressure in the part of the pressure chamber 10 between the check valve 25 and the main line valve 8 drops below the pressure threshold value, which is also referred to as the pressure relief threshold value, the pressure relief valve 24 closes the pressure relief line 21 again. The pressure in the part of the pressure chamber 10 between the check valve 25 and the main line valve 8 is higher than the motor retaining value at this point in time. In this state, the pressure relief valve 24 is in an intermediate position. In this intermediate position, the pressure relief valve 24 is closed. At the same time, the valve member of the pressure relief valve 24 causes the motor 4 to continue to be held in the off-state. In the exemplary embodiments, the valve member of the pressure relief valve 24 is operatively connected to the actuating element 27 of the disconnecting device 40 in such a way that the actuating element 27 actuates the switch 26 of the motor 4 in such a way that the motor 4 is in the off-state when the pressure in the part of the pressure chamber 10 between the check valve 25 and the main line valve 8 acts with at least the motor retaining value on the disconnecting device 40. The force acting on the actuating element 27 due to the retaining pressure is great enough that the actuating element 27 is pressed against the switch 26. The motor 4 continues to remain in the off-state. The pressure relief valve 24 is closed. The pressure value in the part of the pressure chamber 10 between the check valve 25 and the main line valve 8 is in a retaining pressure value range. The retaining pressure value range is between the motor retaining value and the pressure threshold value. In this state of the pressure washer 1, the check valve 25 is closed, the pressure relief valve 24 is closed, the main line valve 8 is closed, and the disconnecting device 40 causes the motor to be in the off-state. This state is stable until the main line valve 8 is opened and the pressure value in the part of the pressure chamber 10 between the check valve 25 and the main line valve 8 decreases below the motor retaining value. Then, the force which acts on the actuating element 27 due to the pressure in the part of the pressure chamber 10 between the check valve 25 and the main line valve 8 no longer suffices for the actuating element 27 to be pressed onto the switch 26 against the force of the spring 29. As soon as the switch 26 is no longer pressed, it springs back into its unactuated state and the motor 4 is switched to its on-state. The switch 26 is pretensioned into its unactuated state. For this purpose, a spring which is not depicted can be provided. Another mechanism, however, can also serve this purpose. Typically, the switch 26 is a microswitch.

As described above, the pressure washer 1 is configured such that in the unactuated state of the control element 42, the size of the open cross-sectional area of the bypass device 30 is maximal. However, this is not the case in every situation. So that the pressure threshold value is reached during or after the closing of the main line valve 8 in the pressure chamber 10, the size of the open cross-sectional area of the bypass device 30 must be at least so small that the pressure in the pressure chamber 10 corresponds at least to the pressure threshold value, independently of an actuation, in particular a degree of actuation, of the control element 42, when the main line valve 8 is in the closed state and simultaneously the motor 4 is in the on-state. Accordingly, the bypass valve 13 adjusts the size of the open cross-sectional area independently of an actuation of the control element 42, in particular a degree of actuation of the control element 42, to be at least so small that the pressure in the pressure chamber 10 corresponds at least to the pressure threshold value when the main line valve 8 is in the closed state and simultaneously the motor 4 is in the on-state. In particular, the bypass valve 13, in particular the servomotor 16, reduces the size of the open cross-sectional area independently of an actuation of the control element 42, in particular a degree of actuation of the control element 42, at least to the extent that the pressure in the pressure chamber 10 corresponds at least to the pressure threshold value when the main line valve 8 is in the closed state and simultaneously the motor 4 is in the on-state. In the exemplary embodiments, this is controlled by means of the control unit 22.

When the main line valve 8 is in the closed state and simultaneously the motor 4 is in the on-state, liquid is prevented from flowing through the bypass device 30 by means of the bypass valve 13 in the exemplary embodiments. In particular, the control unit 22 controls the servomotor 16 in this situation such that the bypass device 30 is closed. In other words, the cross-sectional surface of the bypass device is zero.

In particular, it is provided that the bypass valve 13, in particular the servomotor 16, in particular the control unit 22, adjusts the size of the open cross-sectional area of the bypass device 30 independently of an actuation of the control element 42, in particular independently of a degree of actuation of the control element 42, to be at least so small, in particular reduces it to such an extent that the pressure in the pressure chamber 10 corresponds at least to the pressure threshold value when the main line valve 8 is in the transition from the completely opened state to the closed state, in particular the main line valve is not in the completely opened state, and simultaneously the motor is in the on-state.

The pressure washer 1 is configured such that the bypass valve 13 adjusts the size of the open cross-sectional area of the bypass device 30 for a start-up phase of the motor 4 independently of the degree of actuation of the control element 42 in such a way that the bypass device 30 fluidically connects the pressure chamber 10 and the suction chamber 9. This enables liquid to flow from the pressure chamber 10 through the bypass device 30 into the suction chamber 9 during the start-up phase. In this way, the pressure against which the motor 4 has to work in the start-up phase is reduced. The motor 4 can circulate the liquid by means of the high-pressure pump 3 in the start-up phase. In particular, the pressure relief line 21, in particular the pressure relief valve 24, is closed during the start-up phase. In particular, the pressure in the pressure chamber 10 during the start-up phase is lower than the pressure threshold value.

The start-up phase of the motor 4 ends after a termination condition arises. In the exemplary embodiments, the termination condition arises when a time interval, measured from the start-up of the motor 4, has expired. The start-up of the motor 4 is in particular effected by the control unit 22. Instead or in addition, it can also be provided that the control unit is supplied with information regarding the start time of the motor 4. The start-up of the motor 4 is in particular triggered by the actuation of the control device 7, in particular of the valve control element 41. In particular, the control unit 22 measures the time interval from the start-up of the motor 4. The time interval is 150 ms to 300 ms, in particular 200 ms to 250 ms.

Alternatively, it can also be provided that the termination condition arises when a start-up volume threshold value, in particular a start-up pressure value, is exceeded in the pressure chamber 10. In particular, the start-up pressure value is lower than the pressure threshold value. In particular, the motor retaining value is higher than the start-up pressure value. To measure the start-up pressure value and/or the start-up volume threshold value, suitable measurement devices can be provided. In particular, the measurement values from the corresponding measurement devices can be transmitted to the control unit 22.

The bypass valve 13, in particular the servomotor 16, in particular the control unit 22, adjusts the open cross-sectional area for the start-up phase of the motor 4 such that a pressure compensation between the pressure chamber 10 and the suction chamber 9 occurs through the bypass device 30, in particular through the bypass line 12. In particular, the bypass valve 13, in particular the servomotor 16, in particular the control unit 22, adjusts the open cross-sectional area for the start-up phase of the motor such that its size is maximal. In this way, the volume flow in the bypass device 30, in particular through the bypass valve 13, can be maximal. This enables the pressure against which the motor 4 has to work in the start-up phase to be minimal.

Due to the fact that the bypass device 30, in particular the bypass valve 13, in particular the servomotor 16, in particular the control unit 22, is used during the start-up phase to reduce, in particular to minimise, the counterpressure on the motor 4, in particular on the high-pressure pump 3, further structural measures such as, for example, the provision of a separate start-up line, which provides a further fluid connection possibility between the pressure chamber 10 and the suction chamber 9, can be forgone. A start-up valve is not required either. This saves costs and installation space and enables a simple design of the pressure washer 1.

Due to the fact that the bypass device 30, in particular the bypass valve 13, in particular the servomotor 16, in particular the control unit 22, is used to adjust the size of the open cross-sectional area of the bypass device 30 to be at least so small that the pressure in the pressure chamber 10 corresponds at least to the pressure threshold value when the main line valve 8 is in the closed state and simultaneously the motor 4 is in the on-state, structural measures, such as, for example, the provision of a pressure build-up valve in the bypass line, can be forgone. This saves costs and installation space and ensures a simple design of the pressure washer 1. Skillfully, the bypass device 30, which is actually provided to regulate the pressure in the pressure chamber 10, is used to establish a fluid connection between the pressure chamber 10 and the suction chamber 9 during the start-up phase of the motor 4 and/or to reach the pressure threshold value in the pressure chamber 10 when the main line valve 8 is in the closed state and simultaneously the motor 4 is in the on-state, such that the motor 4 can be brought into the off-state by means of the disconnecting device 40. In both cases, this is an additional use of the bypass device 30.

The pressure washer 1 is operated in a start-up operation during the start-up phase. When the main line valve 8 is in the closed state and simultaneously the motor 4 is in the off-state, the pressure washer 1 is operated in a pressure relief operation. Outside of the start-up operation and outside of the pressure relief operation, the pressure washer 1, in particular in the switched-on state of the main switch 19, is operated in a normal operation.

The size of the open cross-sectional area of the bypass device 30 depends exclusively on the actuation, in particular the degree of actuation, of the control element 42, when the main line valve 8 is in the completely opened state and/or when the pressure washer 1 is outside the start-up phase. In normal operation of the pressure washer 1, the size of the open cross-sectional area of the bypass device 30 depends exclusively on the degree of actuation of the control element 42. In particular, in normal operation, a control signal generated by actuation of the control element 42 is no longer overridden by the control unit 22.

After the start-up phase has finished and/or when the main line valve 8 is in the completely opened state, in particular in normal operation, the pressure in the pressure chamber 10 of the main line 5 can be adjusted depending on the degree of actuation of the control element 42.

In particular, it is provided that, outside the start-up phase and/or when the main line valve 8 is in the completely opened state, in particular in normal operation, the size of the open cross-sectional area at least does not increase, in particular decreases, with an increasing degree of actuation of the control element 42. This applies in particular when the main line valve 8 is in the completely opened state. In particular, the pressure in the pressure chamber 10 of the main line 5 increases or remains the same when the degree of actuation of the control element, in particular in normal operation, increases.

The start-up phase can be triggered several times in succession. The start-up phase can be triggered when the motor 4 is brought into the on-state for the first time after the pressure washer 1 is switched on by means of the main switch 19. The start-up phase can also be triggered when the disconnecting device 40 no longer causes the motor 4 to be in the off-state. In particular when the switch 26 is no longer actuated by the actuation element 27, the motor 4 is switched to an on-state, and the start-up phase begins. In the exemplary embodiments, the bypass device 30, in particular the bypass valve 13, is then completely opened independently of the actuation, in particular the degree of actuation, of the control element 42. This continues until the start-up phase finishes, in particular because the termination condition arises. Afterwards, the pressure washer 1 is operated in normal operation.

In particular, the main line valve 8 is closed during the start-up phase. It can, however, also be provided that the main line valve 8 is opened or is open during the start-up phase. After the start-up phase finishes, the pressure washer 1 is operated in normal operation and the size of the open cross-sectional area of the bypass device 30 depends exclusively on the degree of actuation of the control element 42.

1.-20. (canceled)

21. A pressure washer, comprising:
a high-pressure pump (3);
a main line (5) in fluid communication with the high-pressure pump (3), the main line (5) including
a suction chamber (9) upstream of the high-pressure pump (3), and
a pressure chamber (10) downstream of the high-pressure pump (3);
a motor (4) configured to drive the high-pressure pump (3);
a control element (42); and
a bypass device (30) arranged between the pressure chamber (10) and the suction chamber (9), the bypass device (30) being configured to fluidically connect the pressure chamber (10) and the suction chamber (9),
wherein the bypass device (30) comprises a bypass valve (13),
wherein, to regulate pressure in the pressure chamber (10) by the bypass valve (13), a size of an open cross-sectional area of the bypass device (30) is adjustable depending on a degree of actuation of the control element (42), and
wherein, during a start-up phase of the motor, the bypass valve (13) adjusts the size of the open cross-sectional area independently of the degree of actuation of the control element (42) such that the bypass device (30) fluidically connects the pressure chamber (10) and the suction chamber (9).

22. The pressure washer according to claim 21,
wherein the start-up phase of the motor (4) ends after a termination condition arises.

23. The pressure washer according to claim 22,
wherein the termination condition arises when a time interval, measured from start-up of the motor (4), has expired.

24. The pressure washer according to claim 23,
wherein the time interval is 150 ms to 300 ms.

25. The pressure washer according to claim 21,
wherein, during the start-up phase of the motor (4), the bypass valve (13) adjusts the open cross-sectional area such that pressure compensation occurs between the pressure chamber (10) and the suction chamber (9) through the bypass device (30).

26. The pressure washer according to claim 21,
wherein, during the start-up phase of the motor (4), the bypass valve (13) adjusts the open cross-sectional area to a maximum size.

27. The pressure washer according to claim 21,
wherein, after the start-up phase has ended, the size of the open cross-sectional area depends exclusively on the degree of actuation of the control element (42).

28. The pressure washer according to claim 21,
wherein, outside of the start-up phase, the size of the open cross-sectional area at least does not increase as the degree of actuation of the control element (42) increases.

29. The pressure washer according to claim 21,
wherein the bypass valve (13) is adjustable by a servomotor (16).

30. A method for operating a pressure washer (1), the pressure washer (1) including
a high-pressure pump (3),
a main line (5) in fluid communication with the high-pressure pump (3), the main line (5) including
a suction chamber (9) upstream of the high-pressure pump (3), and
a pressure chamber (10) downstream of the high-pressure pump (3),
a motor (4) configured to drive the high-pressure pump (3),
a control element (42), and
a bypass device (30) with a bypass valve (13) arranged between the pressure chamber (10) and the suction chamber (9), the bypass device (30) being configured to fluidically connect the pressure chamber (10) and the suction chamber (9),
the method comprising:
regulating pressure in the pressure chamber (10) by adjusting, with the bypass valve (13), a size of an open cross-sectional area of the bypass device (30) depending on a degree of actuation of the control element (42); and
during a start-up phase of the motor (4), adjusting, with the bypass valve (13), the size of the open cross-sectional area independently of the degree of actuation of the control element (42) such that the bypass device (30) fluidically connects the pressure chamber (10) and the suction chamber (9).

31. A pressure washer comprising:
a high-pressure pump (3);
a main line (5) in fluid communication with the high-pressure pump (3), the main line (5) including
a suction chamber (9) upstream of the high-pressure pump (3), and
a pressure chamber (10) downstream of the high-pressure pump (3);
a main line valve (8) arranged in the main line (5), the main line valve (8) having a closed state and a completely opened state;
a motor (4) configured to drive the high-pressure pump (3), the motor (4) having an on-state and an off-state;
a disconnecting device (40), by which the motor (4) can be brought into the off-state;
a control element (42); and
a bypass device (30) including a bypass valve (13) arranged between the pressure chamber (10) and the suction chamber (9), the bypass device (30) being configured to fluidically connect the pressure chamber (10) and the suction chamber (9),
wherein, to regulate pressure in the pressure chamber (10) by the bypass valve (13) a size of an open cross-sectional area of the bypass device (30) is adjustable by the control element (42),
wherein the pressure washer is configured such that, based on the pressure in the pressure chamber (10), the disconnecting device (40) brings the motor (4) into the off state when the pressure in the pressure chamber (10) corresponds at least to a pressure threshold value, and
wherein the pressure washer is configured such that, when the main line valve (8) is in the closed state and the motor (4) is in the on state, the bypass valve (13) adjusts the size of the open cross-sectional area independently of actuation of the control element (42) to be at least sufficiently small that the pressure in the pressure chamber (10) corresponds at least to the pressure threshold value.

32. The pressure washer according to claim 31,
wherein, when the main line valve (8) is in the closed state and the motor (4) is in the on state, the bypass valve (13) prevents liquid from flowing through the bypass device (30).

33. The pressure washer according to claim 31,
wherein the bypass valve (13) adjusts the size of the open cross-sectional area independently of actuation of the control element (42) to be at least sufficiently small that the pressure in the pressure chamber (10) corresponds at least to the pressure threshold value when the main line valve (8) is transitioning from the completely opened state to the closed state and the motor (4) is in the on state.

34. The pressure washer according to claim 31,
wherein the bypass valve (13) adjusts the size of the open cross-sectional area independently of actuation of the control element (42) to be at least sufficiently small that the pressure in the pressure chamber (10) corresponds at least to the pressure threshold value when the main line valve (8) is not in the completely opened state and the motor (4) is in the on state.

35. The pressure washer according to claim 31,
wherein the disconnecting device (40) is fluidically connected to the pressure chamber (10).

36. The pressure washer according to claim 31,
wherein the size of the open cross-sectional area depends exclusively on actuation of the control element (42) when the main line valve (8) is in the completely opened state.

37. The pressure washer according to claim 31,
wherein the size of the open cross-sectional area depends on a degree of actuation of the control element (42) when the main line valve (8) is in the completely opened state.

38. The pressure washer according to claim 31,
wherein the bypass valve (13) is adjustable by a servomotor (16).

39. The pressure washer according to claim 31,
wherein the main line valve (8) is actuatable by a valve control element (41).

40. A method for operating a pressure washer (1), the pressure washer (1) including:
a high-pressure pump (3);
a main line (5) in fluid communication with the high-pressure pump (3), the main line (5) including
a suction chamber (9) upstream of the high-pressure pump (3), and
a pressure chamber (10) downstream of the high-pressure pump (3);
a main line valve (8) arranged in the main line (5), the main line valve (8) having a closed state and a completely opened state;
a motor (4) configured to drive the high-pressure pump (3), the motor (4) having an on-state and an off-state;
a disconnecting device (40), by which the motor (4) can be brought into the off-state;
a control element (42);
a bypass device (30) including a bypass valve (13) arranged between the pressure chamber (10) and the suction chamber (9), the bypass device (30) being configured to fluidically connect the pressure chamber (10) and the suction chamber (9),
the method comprising:
regulating pressure in the pressure chamber (10) by adjusting, with the bypass valve (13), a size of an open cross-sectional area of the bypass device (30) by the control element (42),
bringing, by the disconnecting device (40), the motor (4) into an off state when pressure in the pressure chamber (10) corresponds at least to a pressure threshold value; and
when the main line valve (8) is in a closed state and the motor (4) is in an on state, adjusting, with the bypass valve (13), the size of the open cross-sectional area independently of actuation of the control element (42) to be at least sufficiently small that the pressure in the pressure chamber (10) corresponds at least to the pressure threshold value.
